(19) United States
(12) Patent Application Publication
(10) Pub. No.: US 2018/0251012 A1
(43) Pub. Date: Sep. 6, 2018

(54) VEHICULAR DEFROSTER DUCT STRUCTURE

(71) Applicant: CALSONIC KANSEI CORPORATION, Saitama (JP)

(72) Inventor: Masahiro SANO, Saitama (JP)

(73) Assignee: CALSONIC KANSEI CORPORATION, Saitama (JP)

(21) Appl. No.: 15/756,915

(22) PCT Filed: Sep. 8, 2016
(86) PCT No.: PCT/JP2016/076444

§ 371 Date: Mar. 1, 2018

(30) Foreign Application Priority Data
Sep. 16, 2015 (JP) 2015-183055

(51) Int. Cl. B60H 1/24; B60H 1/34

(52) U.S. Cl. CPC B60H 1/242; B60H 1/3407

(57) ABSTRACT

Achieving a high fogging-removal performance with a defroster duct having a small width in the vehicle width direction. A vehicular defroster duct structure includes a defroster duct unit which includes a left defroster duct and a right defroster duct. The left defrost duct is curved leftward and the right defroster duct is curved rightward from the central line X in the vehicle width direction. At least one of the left and right defroster ducts includes a first guide surface and a second guide surface on an inner wall surface thereof close to the central line X. The first guide surface guides air-conditioning air toward a lower corner are of the windshield. The second guide surface guides the air-conditioning air toward a center upper part of the windshield.

### CROSS-REFERENCE TO RELATED APPLICATION

The present application is based on and claims priority from Japanese Patent Application No. 2015-183055, filed on Sep. 16, 2015, the disclosure of which is hereby incorporated by reference in its entirety.

### TECHNICAL FIELD

This disclosure relates to a vehicular defroster duct structure. The defroster duct structure guides air-conditioning air blown from an air-conditioning unit to a defroster air outlet.

### BACKGROUND ART

A vehicular air-conditioning apparatus includes a defroster to remove fog on the windshield. For the defroster, the defroster duct is expected to have a large opening width at an air outlet for the air-conditioning air in order to achieve a high fogging-removal performance.

However, it is sometimes difficult for a vehicle installed with a head-up display to secure a sufficient opening width at the air outlet. In order to achieve a high fogging-removal performance for a vehicle with a head-up display, JP2015-003605A (Patent Literature 1 (PLT1)) teaches to dispose a partition plate and an air blow plate inside the defroster duct so as to expand an area to which the air-conditioning air is distributed.

### SUMMARY

### Technical Problem

As the defroster duct structure taught by PLT1 includes the partition plate and the air blow plate inside the defroster duct, it disadvantageously increases noise when using the defroster and the manufacturing cost.

An object of this disclose is, therefore, to provide a vehicular defroster duct structure which is capable of achieving a high fogging-removal performance without increasing noise and the manufacturing cost even if the opening width of the air outlet of the defroster duct is relatively small.

### Solution to Problem

A vehicular defroster duct structure according to this disclosure includes an air-conditioning unit configured to generate air-conditioning air, a defroster air outlet, and a defroster duct unit connected with the air-conditioning unit and configured to guide the air-conditioning air from the air-conditioning unit to the defroster air outlet. The defroster duct unit includes a left defroster duct curved leftward of a windshield from a central line of a vehicle in a vehicle width direction, and a right defroster duct curved rightward of the windshield from the central line of the vehicle in the vehicle width direction. At least one of the left defroster duct and the right defroster duct is formed with a first guide surface and a second guide surface on an inner wall surface thereof close to the central line. The second guide surface is shifted from the first guide surface in a vehicle longitudinal direction. The first guide surface is configured to guide the air-conditioning air toward a lower corner area of the windshield along a curved shape of the windshield and the second guide surface is configured to guide the air-conditioning air toward a center upper part of the windshield.

### BRIEF DESCRIPTION OF DRAWINGS

FIG. 1 is a block diagram showing a functional configuration of a vehicular air-conditioning apparatus according to a First Embodiment of this disclosure. FIG. 2A is a perspective view showing an external appearance of a defroster duct unit shown in FIG. 1. FIG. 2B is a perspective view showing the defroster duct unit when viewed from the opposite side of FIG. 2A. FIG. 3 is a view showing the defroster duct unit of FIG. 2A mounted on a vehicle when viewed from an upper side of an instrument panel. FIG. 4 is a view showing the defroster duct unit of FIG. 2A mounted on the vehicle when viewed from a side of the instrument panel. FIG. 5A is a view for explaining a challenge in designing the defroster duct unit of the First Embodiment. FIG. 5B is a view for explaining an operation of a first guide surface of the defroster duct unit of the First Embodiment. FIG. 5C is a view for explaining an operation of the first guide surface and a second guide surface of the defroster duct unit of the First Embodiment. FIG. 6 is a view showing a defroster duct unit of a comparative example mounted on the vehicle when viewed from the upper side of the instrument panel.

### DESCRIPTION OF EMBODIMENT

### First Embodiment

Hereinafter, an embodiment of a vehicular air-conditioning apparatus to which a vehicular defroster duct structure of this disclosure is applied will be described with reference to the accompanying drawings.

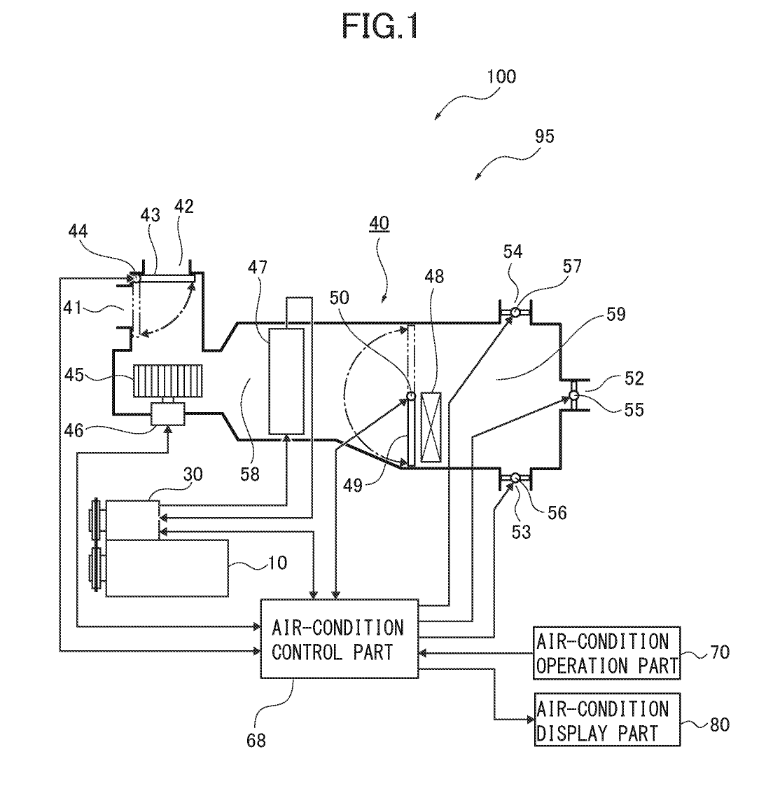

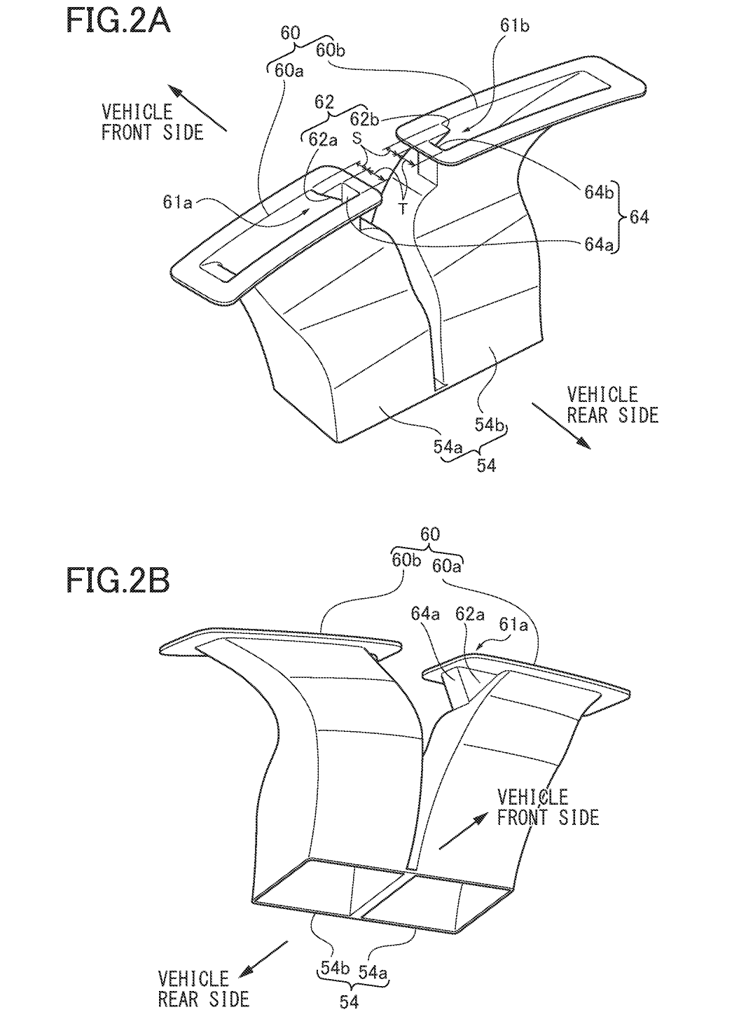

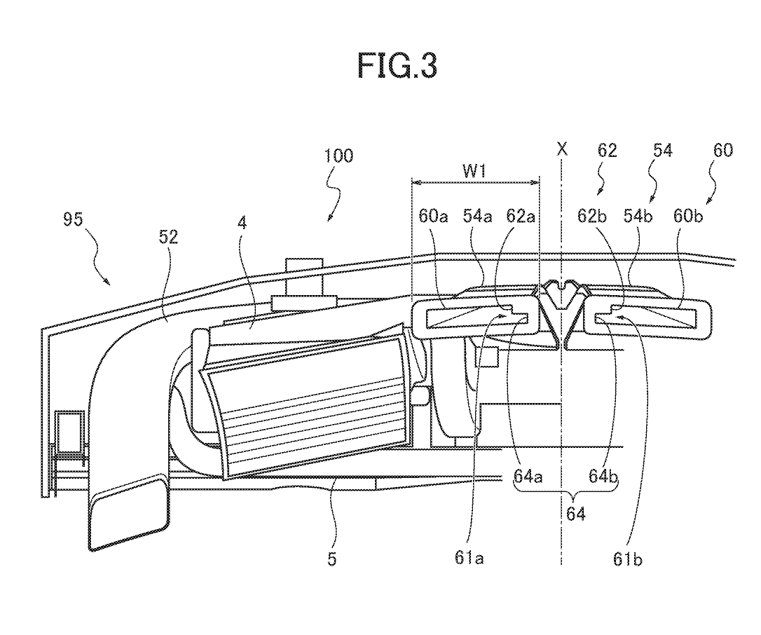

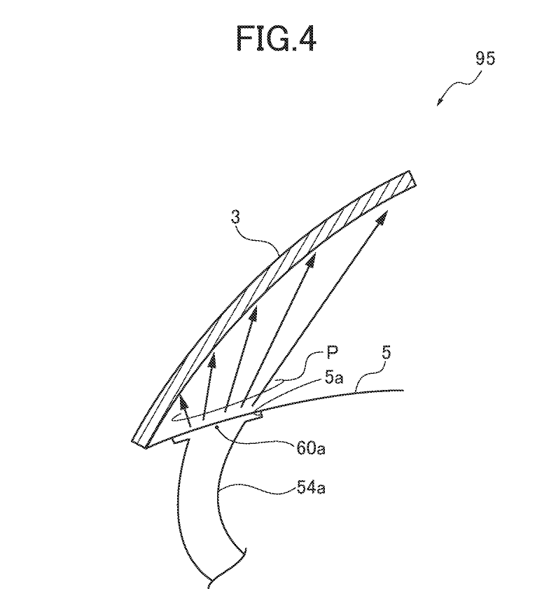

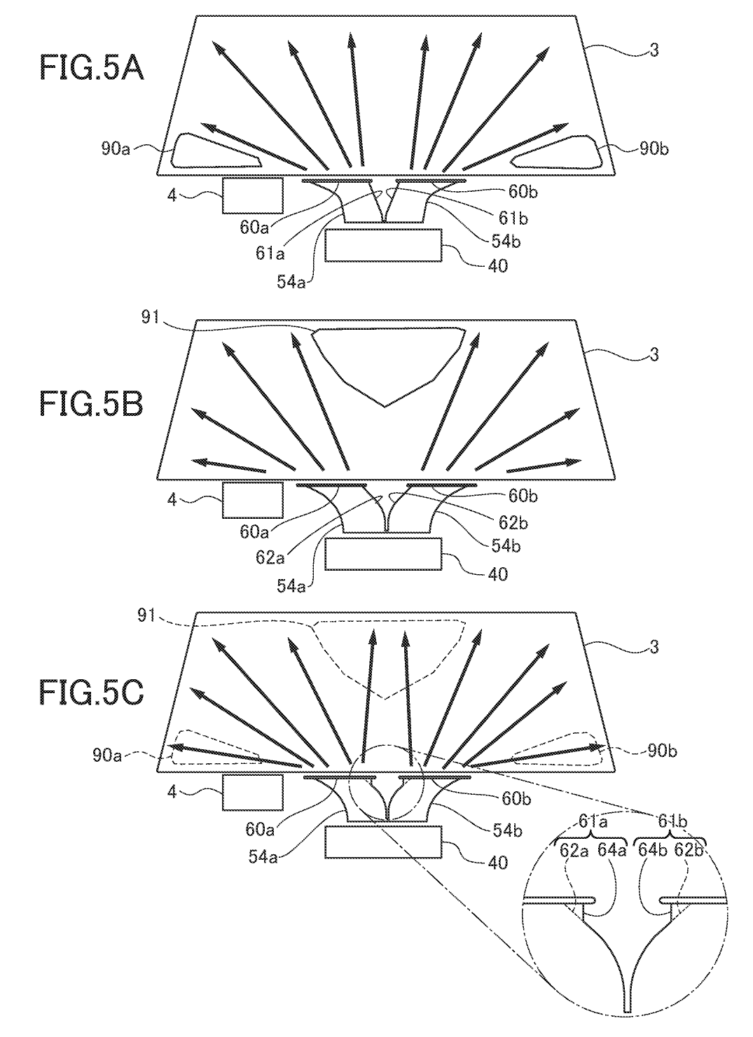

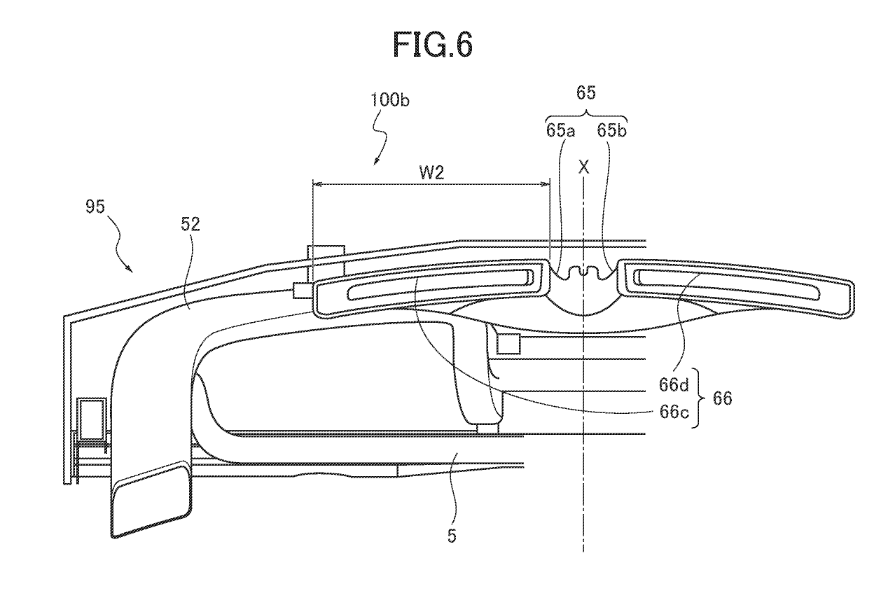

First, an overall configuration of a vehicular air-conditioning apparatus 100 will be described with reference to FIG. 1.

### Overall Configuration of Vehicular Air-Conditioning Apparatus

FIG. 1 is a block diagram showing a functional configuration of the vehicular air-conditioning apparatus 100 according to the First Embodiment of this disclosure.

The vehicular air-conditioning apparatus 100 is installed to a vehicle 95, and includes an air compressor 30 and an air-conditioning unit 40.

The air compressor 30 is driven by an engine 10 to pressurize refrigerant.

The air-conditioning unit 40 is installed inside an instrument panel (not shown in FIG. 1) and controls air conditioning in the vehicle cabin. The air-conditioning unit 40 includes an outside air inlet 41, an inside air inlet 42, an intake door 43, an intake door driver 44, a blower fan (air blower) 45, a blower motor 46, an evaporator 47, a heater core 48, an air mix door 49, and an air mix door driver 50. The evaporator functions as a heat exchanger for cooling air, and the heater core 48 functions as a heat exchanger for heating air.

The outside air inlet 41 introduces the air outside the vehicle 95.

The inside air inlet 42 introduces the air inside the cabin of the vehicle 95.

The intake door 43 is rotated by the intake door driver 44 to switch from the inside air introduction to the outside air introduction, and vice versa, and to change a mixing rate of the inside air and the outside air.

The blower fan 45 is rotated by the blower motor 46 to blow the outside air, the inside air, and/or the mixed air thereof introduced through the intake door 43 to an air passage 58 provided inside the air-conditioning unit 40.

The refrigerant pressurized by the compressor 30 passes through the evaporator 47. Therefore, the air blown to the evaporator 47 is cooled by the evaporator 47 as the refrigerant is evaporated.

The heater core 48 circulates cooling water delivered from the engine 10 through a cooling water passage (not shown) and heats the air blown to the heater core 48.

The air mix door 49 is disposed between the evaporator 47 and the heater core 48. The air mix door driver 50 changes an opening or an opening amount of the air mix door 49 to control the mixing rate of the cool air passed through only the evaporator 47 and the warm air passed through the heater core 48 after being passed through the evaporator 47.

At the downstream of the heater core 48, a mixing chamber 59 is provided. In the mixing chamber 59, the cool air passed through the evaporator 47 and the warm air passed through the heater core 48 are mixed.

The mixing chamber 59 includes a vent duct 52, a foot duct 53, and a defroster duct unit 54. The vent duct 52 is connected to a vent grill (not shown) provided in the vehicle cabin. The foot duct 53 is connected to a foot grill (not shown). The defroster duct unit 54 is connected to a defroster grill (not shown).

A vent door 55 is disposed in the vicinity of an air outlet of the vent duct 52. The vent door 52 rotates between a full-open position and a full-closed position and adjusts an air volume blown from the vent duct 52.

A foot door 56 is disposed in the vicinity of an air outlet of the food duct 53. The foot door 56 rotates between a full-open position and a full-closed position and adjusts an air volume blown from the foot duct 53.

A defroster door 57 is disposed in the vicinity of an air outlet of the defroster 54. The defroster door 57 rotates between a full-open position and a full-closed position and adjusts an air volume blown from the defroster duct unit 54.

The vehicular air-conditioning apparatus 100 includes an air-condition control part 68 to control each element in the apparatus. The air-condition control part 68 is connected with several sensors (not shown), an air-condition operation part 70, and an air-condition display part 80. The sensors are provided to detect the temperature environment inside and outside of the vehicle 95 and to detect the driving condition of the vehicle 95. The air-condition operation part 70 is provided to allow an occupant of the vehicle 95 to set the air condition in the vehicle cabin. The air-condition display part 80 is provided to visually show and inform the occupant of the vehicle 95 about the operation condition of the air-conditioning unit 40.

Next, a detailed structure of the defroster duct unit 54 will be described with reference to FIG. 2A, FIG. 2B, FIG. 3, and FIG. 4.

### Detailed Structure of Defroster Duct

FIG. 2A is a perspective view showing an external appearance of the defroster duct unit 54. FIG. 2B is a perspective view showing the external appearance of the defroster duct unit 54 when viewed from the opposite side of FIG. 2A. FIG. 3 is a view showing the defroster duct unit 54 mounted on the vehicle 95 when viewed from an upper side of the instrument panel 5. FIG. 4 is a sectional view showing a left defroster duct 54a mounted on the vehicle 95 when viewed from a left side of the vehicle 95.

As shown in FIG. 2A, the defroster duct unit 54 includes the left defroster duct 54a and a right defroster duct 54b and is mounted on the vehicle. In FIG. 2A, the back of the paper corresponds to the front side of the vehicle. The end portion (top end portion) of the left defroster duct 54a is formed with a left-defroster air outlet 60a which has a long rectangular-shaped opening to blow out the air-conditioning air. The end portion (top end portion) of the right defroster duct 54b is formed with a right-defroster air outlet 60b which has a long rectangular-shaped opening to blow out the air-conditioning air. The left-defroster air outlet 60a and the right-defroster air outlet 60b together constitute a defroster air outlet 60.

As shown in FIG. 2A and FIG. 2B, the left defroster duct 54a and the right defroster duct 54b are formed to be curved such that the passages thereof gradually spread and expand in the vehicle width direction toward the left-defroster air outlet 60a and the right-defroster air outlet 60b.

In this embodiment, the left defroster duct 54a and the right defroster duct 54b, which constitute the defroster duct unit 54, are arranged asymmetrically to a central line X in the vehicle width direction of the vehicle 95, as shown in FIG. 3. The air-conditioning air passed through the left defroster duct 54a is blown out from the left-defroster air outlet 60a toward the front of the paper in FIG. 3. The air-conditioning air passed through the right defroster duct 54b is blown out from the right-defroster air outlet 60b toward the front of the paper in FIG. 3. Here, the let defroster duct 54a and the right defroster duct 54b do not need to be arranged asymmetrical. As show in FIG. 3, the vent duct 52 explained with reference to FIG. 1 is extended inside the instrument panel 5 in the vehicle width direction and curved toward the driver seat at the side end of the instrument panel 5.

As shown in FIG. 3, the instrument panel 5 of the vehicle 95 includes a head-up display device 4 inside thereof. The head-up display device 4 is a device that provides a virtual image in front of the driver's seat so as to improve visibility of the driver. That is, an image generated by the head-up display device 4 is projected toward the windshield (not shown) to form a virtual image in front of the driver's seat.

In order to improve the visibility of the virtual image formed by the head-up display device 4, it is preferable to enlarge the size of the virtual image and to set the display position (imaging position) of the virtual image away from the driver's seat. To this end, it is necessary to increase the size of the head-up display 4 including optical path forming components of an optical system for imaging the virtual image.

If the size of the head-up display device 4 is increased, a space for installing the defroster duct unit 54 is limited. That is, as shown in FIG. 3, the width W1 of the left-defroster air outlet 60a and the right-defroster air outlet 60b is limited and is shorter than that in a comparative example, as described later. Alternatively, the width W1 of the defroster air outlet (60a, 60b) provided on the side to which the head-up display device 4 is installed may be designed to be small, and the width of the defroster air outlet (60a, 60b) provided on the side to which the head-up display device 4 is not installed may be designed to be large relatively (e.g., as large as that of the conventional technique, see width W2 in FIG. 6).

As shown in FIG. 4, the left defroster duct 54a is disposed inside the instrument panel 5 of the vehicle 95. To be specific, the left-defroster air outlet 60a of the left defroster duct 54a is aligned with an opening 5a on the top surface of the instrument panel 5. Accordingly, the air-conditioning air blown from the left defroster air outlet 60a is delivered to the windshield 3 from the obliquely lower side to remove fogging occurred inside the windshield 3, as indicated by arrows in FIG. 4. The left defroster duct 54a is slightly curved from the front side of the vehicle (i.e., left of paper in FIG. 4) to the rear side of the vehicle (i.e., right of paper in FIG. 4) as the left defroster duct 54a goes from the bottom to the top. That is, the left defroster duct 54a has a curved shape. Accordingly, the air-conditioning air delivered from the air-conditioning unit 40 (see FIG. 1) is smoothly guided to the windshield 3, and thereby the air-conditioning air is uniformly delivered from the top to the bottom of the windshield 3. It should be noted the right defroster duct 54b (see FIG. 3), which is not shown in FIG. 4, has a similar shape to the left defroster duct 54a.

As shown in FIG. 3, the left defroster duct 54a is formed with a first guide surface 62a and a second guide surface 64a on the inner wall surface 61a close to the central line X of the vehicle 95. The first guide surface 62a and the second guide surface 64a are extended in different directions from each other. Further, the right defroster duct 54b is formed with a first guide surface 62b and a second guide surface 64b on the inner wall surface 61b close to the central line X of the vehicle 95. The first guide surface 62b and the second guide surface 64b are extended in different directions from each other.

As shown in FIG. 2A and FIG. 2B, the first guide surface 62a is formed such that a part of the inner wall surface 61a of the left defroster duct 54a extends toward the left in the vehicle width direction as the left defroster duct 54a goes from the bottom to the top. As shown in FIG. 2A, the first guide surface 62b is formed such that a part of the inner wall surface 61b of the right defroster duct 54b extends toward the right in the vehicle width direction as the right defroster duct 54b goes from the bottom to the top. Accordingly, the air-conditioning air, which passes through the left defroster duct 54a or the right defroster duct 54b, is guided along the corresponding first guide surface 62 (62a, 62b) and blown from the left-defroster air outlet 60a toward the left in the vehicle width direction or blown from the right-defroster air outlet 60b toward the right in the vehicle width direction, respectively. The detailed of the air flow will be described later.

As shown in FIG. 2A and FIG. 2B, the second guide surfaces 64 (64a, 64b) are formed such that a part of the inner wall surface 61a of the left defroster duct 54a and a part of the inner wall surface 61b of the right defroster duct 54b extend substantially vertically upward. Accordingly, the air-conditioning air, which passes through the left defroster duct 54a or the right defroster duct 54b, is guided along the second guide surface 64 (64a, 64b) and blown from the left-defroster air outlet 60a or the right-defroster air outlet 60b substantially vertically upward, respectively. The edges of the second guide surfaces 64 (64a, 64b) at the defroster air outlets 60 (60a, 60b) are positioned closer to the central line X than the edges of the first guide surfaces 62 (62a, 62b) at the defroster air outlets 60 (60a, 60b). The second guide surfaces 64 (64a, 64b) respectively cross a part of the inner wall surfaces 61 (61a, 61b) of the defroster duct unit 54 (54a, 54b) in the vertical direction, as said part of the defroster duct unit 54 (54a, 54b) extends and curves outwardly in the vehicle width direction. That is, the second guide surfaces 64 (64a, 64b) are directed toward the center upper part or in the opposite direction to the first guide surfaces 62 (62a, 62b) (i.e., inward direction in vehicle width direction) of the windshield 3. The detailed structure will be described later. Here, if the sizes of the left- and right-defroster air outlets 60 (60a, 60b) are designed to be different from each other, the first guide surface 62 and the second guide surface 64 may be formed only at the defroster air outlet 60 having the smaller width W1 (of course, the first guide surface 62 and the second guide surface 64 can be formed at the defroster air outlet 60 having the larger width W2 as well).

Hereinafter, the defroster duct mounted on the vehicle in a comparative example of this embodiment will be described with reference to FIG. 6.

### Defroster Duct Mounted on Vehicle in Comparative Example

FIG. 6 shows the defroster duct unit 65 (left defroster duct 65a, right defroster duct 65b) of the comparative example mounted on the vehicle 95. In this comparative example, the defroster duct unit 65 is mounted on the vehicle in which the head-up display device 4 shown in FIG. 3 is not installed.

In the comparative example, the space to mount the defroster duct unit 65 to the vehicle is sufficiently secured since the head-up display device 4 (see FIG. 3) is not installed in the vehicle 95. As shown FIG. 6, the width W2 of the left-defroster air outlet 66c formed at the end portion of the left defroster duct 65a is, therefore, designed to be approximately twice as large as the width W1 (see FIG. 3) of the left-defroster air outlet 60a in the First Embodiment. The right-defroster air outlet 66d is designed in the same manner.

That is, in the comparative example shown in FIG. 6, the defroster air outlets 66 (66c, 66d) have the sufficiently large width W2. Accordingly, it is possible to uniformly deliver the air-conditioning air blown from the defroster air outlets 66 (66c, 66d) to the entire windshield. As a result, it is possible to achieve a high fogging-removal performance to sufficiently remove fogging of the windshield.

In contrast to the comparative example, the First Embodiment provides a defroster duct structure including the defroster air outlets 60 (60a, 60b) having the smaller width but capable of achieving a high fogging-removal performance equivalent to that of the comparative example. Hereinafter, operations of the First Embodiment will be described with reference to FIG. 2A, FIG. 5A, FIG. 5B, and FIG. 5C.

### Operation of Defroster Duct

FIG. 5A is a view for explaining a challenge in mounting all the head-up display device 4, the left defroster duct 54a, and the right defroster duct 54b to the vehicle. FIG. 5B is a view for explaining operations of the first guide surface 62a of the left defroster duct 54a and the first guide surface 62b of the right defroster duct 54b. FIG. 5C is a view for explaining operations of the first guide surface 62a and the second guide surface 64a of the left defroster duct 54a, and the first guide surface 62b and the second guide surface 64b of the right defroster duct 54b.

In FIG. 5A, the inner wall surface 61a of the left defroster duct 54a and the inner wall surface 61b of the right defroster duct 54b are formed to have a slightly inclined linear shape. Since the width W1 (see FIG. 3) of the left-defroster air outlet 60a and of the right-defroster air outlet 60b are relatively small, the air-conditioning air, which is blown from the left-defroster air outlet 60a and the right-defroster air outlet 60b and delivered to the windshield 3, does not spread widely with this structure. As a result, the air-conditioning air is not delivered to the areas around the lower left corner area 90a and the lower right corner area 90b of the windshield 3. Additionally, since the inner wall surfaces 61a, 61b are extended outwardly in the vehicle width direction, the air-conditioning air is not delivered to the area around a center upper part of the windshield 3.

In FIG. 5B, in order to deliver the air-conditioning air toward the lower left corner area 90a, the inner wall surface 61a (see FIG. 5A) is curved leftward of the windshield 3 in the vehicle width direction and forms the first guide surface 62a. Similarly, in order to deliver the air-conditioning air toward the lower right corner area 90b, the inner wall surface 61b (see FIG. 5A) is curved rightward of the windshield 3 in the vehicle width direction and forms the first guide surface 62b. By curving the inner wall surfaces 61a, 61b outwardly in the vehicle width direction, the air-conditioning air can reach the lower left corner area 90a and the lower right corner area 90b of the windshield 3.

However, with the above-mentioned first guide surfaces 62a, 62b, the inner wall surfaces 61, 61b are extended outwardly. As a result, compared to the structure of FIG. 5A, the area where the air-conditioning air is not delivered is further increased around the center upper part 91 of the windshield 3.

In FIG. 5C, the inner wall surface 61a (see FIG. 5A) is therefore formed to have the second guide surface 64a in addition to the first guide surface 62a. The second guide surface 64a is directed toward the center upper part 91 of the windshield 3. Similarly, the inner wall surface 61b (see FIG. 5A) is formed to have the second guide surface 64b in addition to the first guide surface 62b. The second guide surface 64b is directed toward the center upper part 91 of the windshield 3.

As described above, the inner wall surfaces 61a, 61b of the embodiment are formed to have two types of surfaces, and one of the two types of the surfaces is directed toward a different direction from the other type. With this, although the width W1 of the left-defroster air outlet 60a and of the right-defroster air outlet 60b are relatively small, it is possible to deliver the air-conditioning air uniformly over the entire windshield 3.

It should be noted that the first guide surface 62a is formed on the vehicle front side of the inner wall surface 61a and the second guide surface 64a is formed on the vehicle rear side of the inner wall surface 61a, as shown in FIG. 2A. Similarly, the first guide surface 62b is formed on the vehicle front side of the inner wall surface 61b and the second guide surface 64b is formed on the vehicle rear side of the inner wall surface 61b, as shown in FIG. 2A.

As described above, the first guide surfaces 62a, 62b and the second guide faces 64a, 64b are formed to be shifted from each other in the vehicle longitudinal direction. With this, the air-conditioning air blown from the defroster air outlets 60 (left-defroster air outlet 60a, right-defroster air outlet 60b) close to the windshield 3 is delivered toward the lower left corner area 90a and the lower right corner area 90b. That is, such air-conditioning air is delivered around the lower left corner area 90a and the lower right corner area 90b of the windshield 3 along inner surface of the windshield 3. As a result, it is possible to efficiently blow and deliver the air-conditioning air toward the lower left corner area 90a and the lower right corner area 90b of the windshield 3.

Further, the air-conditioning air blown from the defroster air outlets 60 (left-defroster air outlet 60a, right-defroster air outlet 60b) away from the windshield 3 is delivered toward the center upper part 91 of the windshield 3. That is, such air-conditioning air is delivered to the center upper part 91 of the windshield 3 along inner surface of the windshield 3. As a result, it is possible to efficiently blow and deliver the air-conditioning air toward the center upper part 91 of the windshield 3.

It should be noted that a ratio of a depth or a length S of the first guide surface 62a to a depth or a length T of the second guide surface 64a, as well as a ratio of a depth or a length S of the first guide surface 62b to a depth or a length T of the second guide surface 64b should be optimized in accordance with the extending direction of the first guide surfaces 62a, 62b and the extending direction of the second guide surfaces 64a, 64b. For example, the ratio may be set as S:T=3:7.

As described above, in the vehicular air-conditioning apparatus 100 including the vehicular defroster duct structure according to the First Embodiment, the defroster duct unit 54 (54a, 54b) includes the left defroster duct 54a and the right defroster duct 54b. The left defroster duct 54a is curved leftward of the windshield 3 from the central line X of the vehicle 95 in the vehicle width direction. The right defroster duct 54b is curved rightward of the windshield 3 from the central line X of the vehicle 95 in the vehicle width direction. At least one of the left defroster duct 54a and the right defroster duct 54b is formed with the first guide surface 62a, 62b and a second guide surface 64a, 64b on the corresponding inner wall surface 61a, 61b thereof close to the central line X. Here, the second guide surface 64a, 64b is shifted from the first guide surface 62a, 62b in the vehicle longitudinal direction. The first guide surfaces 62a, 62b are to guide the air-conditioning air toward the lower corner areas of the windshield 3 in the vehicle width direction. The second guide surfaces 64a, 64b are to guide the air-conditioning air toward the center upper part of the windshield 3. With this, the air-conditioning air blown from the first guide surface 62a, 26b, which is formed on the inner wall surface 61a, 61b close to the vehicle central line of at least one of the left defroster duct 54a and the right defroster duct 54b, is delivered toward the lower corner areas of the windshield 3 in the vehicle width direction. Further, the air-conditioning air blown from the second guide surface 64a, 64b, which is arranged to be shifted from the first guide surface 62a, 62b in the vehicle longitudinal direction, is delivered toward the center upper part of the windshield 3. As a result, even with the defroster air outlets 60 (60a, 60b) having the small width W1, it is possible to achieve a high fogging-removal performance over the entire windshield 3 including the corners and the upper part thereof.

In the vehicular air-conditioning apparatus 100 including the vehicular defroster duct structure according to the First Embodiment, the first guide surfaces 62a, 62b are formed at positions closer to the vehicle front side than the second guide surfaces 64a, 64b. With this, the air-conditioning air blown from the defroster air outlets 60 (left-defroster air outlet 60a, right-defroster air outlet 60b) is delivered toward the lower left corner area 90a, the lower right corner area 90b, and the center upper part 91 of the windshield 3 along the inner surface of the windshield 3. As a result, it is possible to efficiently blow and deliver the air-conditioning air over a wide range of the windshield 3.

The vehicular air-conditioning apparatus 100 including the vehicular defroster duct structure according to the First Embodiment does not require a partition plate or an air blow plate to be disposed inside the defroster duct unit 54. Therefore, it is possible to avoid increasing the ventilation resistance and to avoid increasing the noise. As the defroster duct structure does not have an additional component, it is possible to achieve a high fogging-removal performance without increasing in the manufacturing cost. Further, the edges of the second guide surfaces 64 (64a, 64b) at the defroster air outlets 60 (60a, 60b) are positioned closer to the central line X than the edges of the first guide surfaces 62 (62a, 62b) at the defroster air outlets 60 (60a, 60b). With this, it is possible to improve the fogging-removal performance at the center upper part of the windshield 3. Further, the second guide surfaces 64 (64a, 64b) are configured to cross the inner wall surfaces 61 (61a, 61b) of the defroster duct unit 54 (54a, 54b) in the vertical direction, as the defroster duct unit 54 (54a, 54b) extends and curves outwardly in the vehicle width direction. Accordingly, the second guide surfaces 64 (64a, 64b) are directed toward the center upper part or in the opposite direction to the first guide surfaces 62 (62a, 62b) (i.e., inward direction in vehicle width direction) of the windshield 3. As a result, it is possible to further improve the fogging-removal performance at the center upper part of the windshield 3.

Although the embodiment has been described with reference to the drawings, it should be understood that the embodiment is only an example of this disclosure. This disclosure should not be limited to the embodiment, and it should be appreciated that variations or modifications may be made in the embodiments described by persons skilled in the art without departing from the gist of this disclosure. Further, when the embodiment includes a plurality of elements, any possible combinations of these elements may be possible even without a detailed description. Furthermore, when several embodiments are described in this disclosure, any possible combinations of these configurations that may even across these embodiments may be possible even without a detailed description. Additionally, when the term “and the like”, is used, it means it covers similar elements. Further, when the terms “substantially”, “about”, “around”, etc. are used, it should be considered that they cover ranges and/or accuracy within a technical common sense understood by persons skilled in the art.

### REFERENCE SIGNS LIST

3 Windshield; 40 Air-Conditioning Unit; 54a Left Defroster Duct; 54b Right Defroster Duct; 60 Defroster Air Outlet; 61a, 61b Inner Wall Surface; 62, 62a, 62b First Guide Surface; 64, 64a, 64b Second Guide Surface; 65 Defroster Duct; 95 Vehicle; X Central Line.

What is claimed is:

1. A vehicular defroster duct structure comprising:
an air-conditioning unit configured to generate air-conditioning air;
a defroster air outlet; and
a defroster duct unit connected with the air-conditioning unit and configured to guide the air-conditioning air from the air-conditioning unit to the defroster air outlet; wherein
the defroster duct unit comprises:
a left defroster duct curved leftward of a windshield from a central line of a vehicle in a vehicle width direction, and
a right defroster duct curved rightward of the windshield from the central line of the vehicle in the vehicle width direction,
at least one of the left defroster duct and the right defroster duct is formed with a first guide surface and a second guide surface on an inner wall surface thereof close to the central line,
the second guide surface is shifted from the first guide surface in a vehicle longitudinal direction, and
the first guide surface is configured to guide the air-conditioning air toward a lower corner area of the windshield along a curved shape of the windshield and the second guide surface is configured to guide the air-conditioning air toward a center upper part of the windshield.

2. The defroster duct structure according to claim 1, wherein the first guide surface is formed at a position closer to a vehicle front side than the second guide surface.

3. The defroster duct structure according to claim 1, wherein an edge of the second guide surface at the defroster air outlet is positioned closer to the central line than an edge of the first guide surface at the defroster air outlet.

4. The defroster duct structure according to claim 3, wherein
the inner wall surface of the defroster duct unit is curved outwardly in the vehicle width direction,
the second guide surface is configured to cross a part of the inner wall surface of the defroster duct unit in a vertical direction, and
the second guide surface is directed toward a center upper part of the windshield.
